(19) United States
(12) Patent Application Publication
(10) Pub. No.: US 2015/0296044 A1
(43) Pub. Date: Oct. 15, 2015

(54) METHOD AND CLOUD SERVER FOR PERSONAL PROFILE MATCHING USING EXERCISE INFORMATION

(71) Applicant: MITAC INTERNATIONAL CORP., Taoyuan City (TW)

(72) Inventor: Yung-Ming LIU, Taoyuan City (TW)

(21) Appl. No.: 14/677,088

(22) Filed: Apr. 2, 2015

(30) Foreign Application Priority Data
Apr. 11, 2014 (TW) 103113457

(51) Int. Cl. H04L 29/08; G06F 17/30

(52) U.S. Cl. CPC H04L 67/306; G06F 17/3053

(57) ABSTRACT

In a method for personal profile matching, a cloud server receives a plurality of personal data sets each including a user profile of a user and an entry of exercise information. The exercise information includes an exercise duration and a location. The cloud server further performs a matching analysis between a requiring user and at least one of the remaining ones of the users, which serves as a to-be-matched user, with reference to a correspondence between the exercise information of the requiring user and the exercise information of the to-be-matched user. Afterward, the cloud server determines whether the to-be-matched user is a matched user using result of the matching analysis.

### CROSS-REFERENCE TO RELATED APPLICATION

This application claims priority of Taiwanese Application No. 103113457, filed on Apr. 11, 2014.

### FIELD

The disclosure relates to a method for personal profile matching, and more particularly to a method for personal profile matching using exercise information.

### BACKGROUND

Currently, portable electronic devices (e.g., mobile phones, sport watches, etc.) are configured to operate with a variety of sport-related sensors (e.g., pulse monitors, heart rate monitors, etc.) for recording exercise information of users. The recorded exercise information may be subsequently used for analyzing the state of the corresponding user during exercise, and the effect on the user as attributed to the exercise (e.g., improvement on cardiopulmonary function of the user based on pulses of the user recorded at different times).

### SUMMARY

An object of the disclosure is to provide a method for personal profile matching using exercise information.

According to the disclosure, a method for personal profile matching is to be implemented using a cloud server. The method includes the following steps:

receiving a plurality of personal data sets respectively associated with a plurality of users, each of the personal data sets including a user profile of the user and an entry of exercise information, the exercise information including an exercise duration during which the user exercises and a location where the user exercises;

upon receipt of a friend matching request associated with one of the users, which serves as a requiring user, performing a matching analysis between the requiring user and at least one of the remaining ones of the users, which serves as a to-be-matched user, with reference to a correspondence between the exercise information of the requiring user and the exercise information of the to-be-matched user;

determining, using result of the matching analysis, whether the to-be-matched user is a matched user based on a predetermined matching criterion; and

providing the user profile of said the to-be-matched user to the requiring user if is determined that the to-be-matched user is a matched user.

Another object of the disclosure is to provide a cloud server that is capable of executing the method.

According to the disclosure, a cloud server for profile matching includes a storage medium and a processor unit.

The storage medium is programmed for storing a plurality of personal data sets respectively associated with a plurality of users. Each of the personal data sets includes a user profile of the respective one of the users and an entry of exercise information. The exercise information includes an exercise duration during which the respective one of the users exercises and a location where the respective one of the users exercises.

Upon receipt of a friend matching request associated with one of the users which serves as a requiring user, the processor unit is programmed to:

perform a matching analysis between the requiring user and at least one of the remaining ones of the users, which serves as a to-be-matched user, with reference to a correspondence between the exercise information of the requiring user and the exercise information of the to-be-matched user;

determine, using result of the matching analysis, whether the to-be-matched user is a matched user based on a predetermined matching criterion stored in the storage medium; and

provide the user profile of the to-be-matched user to the requiring user if it is determined that the to-be-matched user is a matched user.

Still another object of the disclosure is to provide a system for personal profile matching.

According to the disclosure, the system includes a plurality of user devices and a cloud server.

Each of the user devices is programmed for storing a personal data set respectively associated with a user thereof. The personal data set includes a user profile of the user and an entry of exercise information. The exercise information includes an exercise duration during which the user exercises and a location where the user exercises.

The cloud server is programmed for communicating with the user devices, and includes a storage medium and a processor unit. Upon receipt of a friend matching request from one of the user devices, the cloud server is operable to:

perform, by the processor unit, a matching analysis between the user of the one of the user devices, which serves as a requiring user, and at least one of the users of the remaining ones of the user devices, which serves as a to-be-matched user, with reference to a correspondence between the exercise information of the requiring user and the exercise information of each of the to-be-matched users,

determine, by the processor unit using result of the matching analysis, whether the to-be-matched user is a matched user based on a predetermined matching criterion stored in the storage medium, and

provide the user profile of the to-be-matched user to the one of the user devices that sends the friend matching request to the cloud server if it is determined that the to-be-matched user is a matched user.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating a system for personal profile matching that includes a cloud server and a plurality of user devices, according to an embodiment of the disclosure;

FIGS. 2 to 4 are block diagrams respectively illustrating various implementations of the user device that is able to communicate with the cloud server.

FIG. 5 is a flow chart illustrating a method for personal profile matching executed by the cloud server and the user devices according to the disclosure; and

FIG. 6 is a flow chart illustrating a matching analysis of the method according to the disclosure.

### DETAILED DESCRIPTION

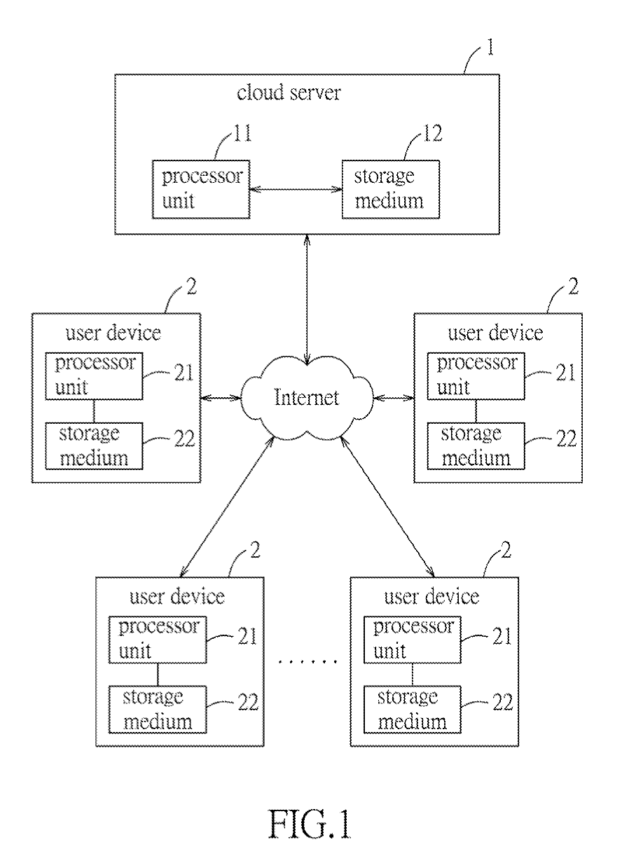

FIG. 1 illustrates a system for personal profile matching according to an embodiment of the present disclosure. The system includes a cloud server 1 and a plurality of user devices 2. The cloud server 1 includes a communication interface (not shown), a processor unit 11 and a storage medium 12. The cloud server 1 is capable of communication with the user devices 2 over a network (e.g., the Internet).

The processor unit 11 may be embodied using one or more cloud computing processors, and the storage medium 12 may be embodied using one or more cloud storage devices. That is to say, the processor unit 11 may include a plurality of cloud computing processors placed in various geographic locations and communicating with one another through the Internet, and the storage medium 12 may include a plurality of cloud storage devices placed in various geographic locations and accessible by the processor unit 11.

In this embodiment, each of the user devices 2 may be embodied using an electronic device such as a mobile device (e.g., a smart phone), an exercise tracking device (e.g., a sport watch with network connectivity and Global Positioning System (GPS) functionality), a personal computer, etc. Each of the user devices 2 is associated with a user, includes a memory 21 and a processor unit 22, and is operable to communicate with the cloud server 1.

Each of the user devices 2 is operable to transmit a personal data set to the cloud server 1. The personal data set is associated with the user of the user device 2, and includes a user profile of the user, an entry of exercise information, an entry of friend preference information, and an entry of physique information. The user profile of the user included in the personal data set may include an account name or a nickname of the user that is registered by the user at the cloud server 1. The entry of exercise information included in the personal data set may include an exercise duration and/or time during which the user exercises and a location where the user exercises. The physique information included in the personal data set may include information about the physique of the user such as gender, age, height, weight, etc. Correspondingly, the friend preference information included in the personal data set may include physique information of a subject (e.g., gender, age, height, weight, etc.), which the user is interested in.

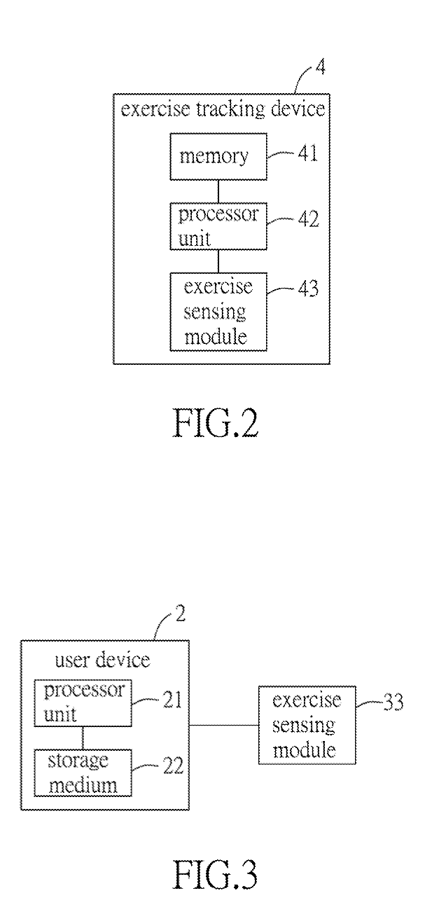

Referring to FIG. 2, a first implementation of the user device 2 is embodied using an exercise tracking device 4. The exercise tracking device 4 includes a memory 41, a processor unit 42 and a built-in exercise sensing module 43. The exercise sensing module 43 is programmed for sensing data related to the exercise taken by the user, and for providing the exercise information associated with the data sensed thereby. The exercise tracking device 4 also includes wireless connectivity and Internet connectivity, and is able to transmit the exercise information to the cloud server 1.

For example, the exercise sensing module 43 includes a timer for timing the exercise duration and optically a time recording device for recording the time of exercise, an accelerometer for sensing acceleration of the user during exercise, a gyroscope for sensing angular velocity of the user during exercise, a heart rate monitor for sensing heart rate of the user during exercise, a pedometer for counting steps, a GPS sensor for sensing GPS signal, etc. The GPS signal sensed by the GPS sensor can be used to locate the location where the user exercises, to record a travelled route along which the user exercises, and to calculate speed of the user during exercise. Besides the above-mentioned various data sensed by the exercise sensing module 43, the exercise information may further include difficulty and category of exercise taken by the user, and a stride length of the user.

It is noted that, since the various data of the exercise information is automatically sensed by the exercise sensing module 43, it cannot be manipulated by the user. As a result, the exercise information may provide relatively high authenticity.

Referring to FIG. 3, a second implementation of the user device 2 is communicatively coupled to an external exercise sensing module 33, which is similar to the exercise sensing module 43 of the exercise tracking device 4 shown in FIG. 2, for receiving the exercise information from the external exercise sensing module 33. The connection between the user device 2 and the external exercise sensing module 33 may be realized using physical connection or wireless connection such as Bluetooth.

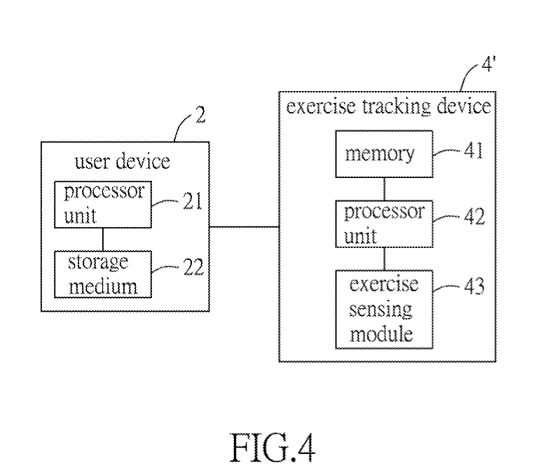

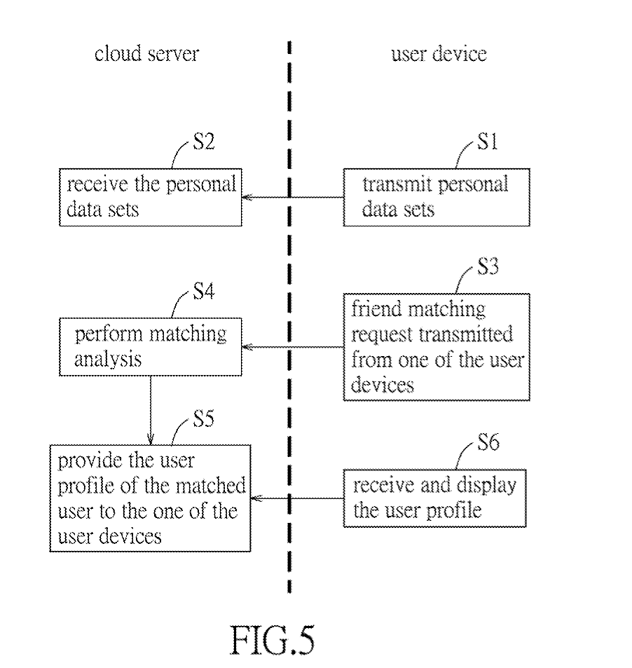

Referring to FIG. 4, a third implementation of the user device 2 is communicatively coupled to an external exercise tracking device 4′ that is similar to the exercise tracking device 4 shown in FIG. 2. The external exercise tracking device 4′ of this implementation is, for example, a sport watch, and may not support Internet connectivity. As such, the external exercise tracking device 4′ is required to be coupled to the user device 2 for transmitting the exercise information to the cloud server 1 (see FIG. 1) therethrough.

Referring to FIGS. 1 and 5, the cloud server 1, in communication with the user devices 2, is programmed to execute, in combination with the user devices 2, a method for personal profile matching according to this disclosure.

In step S1, the user devices 2 transmit the personal data sets to the cloud server 1, respectively. The transmission of the personal data sets may be processed via a webpage provided by the cloud server 1 or an application installed in each of the user devices 2.

For example, the user takes an exercise (e.g., jogging) for a first period of 30 minutes, takes a rest, and then takes the exercise again for a second period of 20 minutes after the rest. The exercise duration of the exercise information may be recorded as a total duration of 50 minutes, i.e., the sum of the first period of 30 minutes and the second period of 20 minutes, without considering the period during which the user takes a rest. Alternatively, the first period of 30 minutes and the second period of 20 minutes may be recorded as two separate exercise durations of the exercise information.

In practice, the (external) exercise sensing module 33, 43 starts timing the exercise duration, and optionally recording the actual time of the exercise, upon receipt of a user inputted command, or may be activated to time the exercise duration, and optionally record the actual time, when detecting a threshold condition (e.g., the speed and/or acceleration of the user becomes greater than a predetermined threshold).

In step S2, the cloud server 1 receives the personal data sets from the user devices 2, respectively.

In step S3, one of the user devices 2 transmits to the cloud server 1 a friend matching request associated with the user of said one of the user devices 2. The user of said one of the user devices 2 that sends the friend matching request serves as a requiring user.

In step S4, upon receipt of the friend matching request, the processor unit 11 of the cloud server 1 performs a matching analysis between the requiring user and at least one of the remaining ones of the users, which serves as a to-be-matched user, with reference to a correspondence between the exercise information of the requiring user and the exercise information of each to-be-matched user.

Specifically, in the matching analysis, a matching score is calculated for each to-be-matched user with respect to the requiring user based on the exercise information of the requiring user (used as a reference basis) and the exercise information of the to-be-matched user.

Using a result of the matching analysis, the processor unit 11 of the cloud server 1 determines whether the to-be-matched user is a matched user based on a predetermined matching criterion that is stored in the storage medium 12. In this embodiment, the predetermined matching criterion specifies a predetermined threshold value, such that any one of the to-be-matched users who has the matching score greater than the predetermined threshold value is determined to be a matched user.

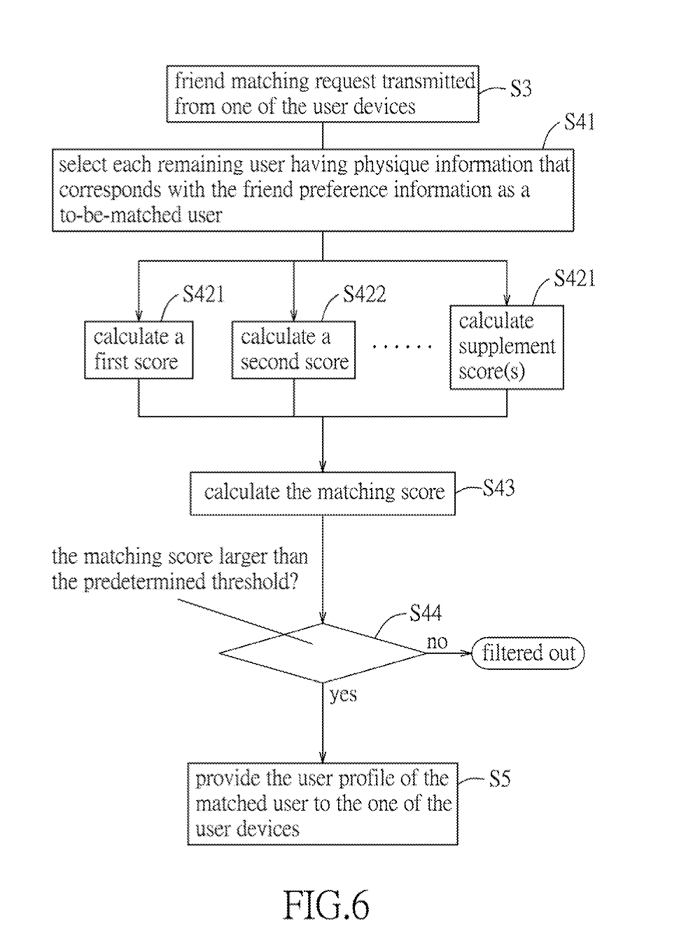

FIG. 6 illustrates an exemplary way for implementing step S4 for each of the to-be-matched users in detail.

In sub-step S41, the processor unit 11 filters out each of the remaining users whose physique information does not correspond with the friend preference information of the requiring user. In such a case, the requiring user may not intend to be acquainted with people who do not correspond with the requiring user's preference. For example, when the friend preference information of the requiring user specifies that the requiring user is interested in a female, the processor unit 11 filters out the male users in sub-step S41, and only the female users are the to-be-matched users. The processor unit 11 proceeds with the following steps to calculate the matching score for each remaining user having the physique information that corresponds with the friend preference information of the requiring user, and omits each remaining user having the physique information that does not correspond with the friend preference information of the requiring user in the following steps. If none of the remaining users has the physique information corresponding with the friend preference information of the requiring user, the method is terminated, and a “no match” message is sent to the user device 2 that sends the friend matching request in step S3.

In sub-step S421, the processor unit 11 calculates a first score for each to-be-matched user with reference to the exercise durations and/or times of the exercise information of the personal data sets that are respectively associated with the requiring user and the to-be-matched user.

The first score may be calculated in the following manner. In one example, the first score is equal to a value of T₃ when the exercise durations of the requiring user and the to-be-matched user are substantially identical, and is equal to a value of T₂ that is lower than the value of T₁ when the exercise durations of the requiring user and the to-be-matched user are not substantially identical.

In another example, assuming each of the requiring user and the to-be-matched users only has one entry of exercise duration, the first score is calculated based on a ratio value (R) that is obtained by dividing a smaller one of the exercise durations (L) by a greater one of the exercise durations (L2). The first score is positively correlated to the ratio value (R=L1/L2).

For instance, when the first score is calculated to equal a value of T₃ based on a ratio value (R₁), a ratio value (R₂), where R₂<R₁ will subsequently obtain a first score having a value of T₄ that is smaller than T₃. That is to say, the first score is negatively correlated with a difference between the exercise durations respectively of the requiring user and the to-be-matched user. In practice, the first score is equal to the ratio value (R=L1/L2).

In sub-step S422, the processor 11 calculates a second score for each to-be-matched user with reference to the locations of the exercise information of the personal data sets that are respectively associated with the requiring user and the to-be-matched user.

The second score may be calculated in the following manner. In one example, the second score is equal to a value of P₁ (say, 1.0) when the locations respectively of the requiring user and the to-be-matched user are situated in the same region (e.g., Taipei City). Otherwise, when the locations respectively of the requiring user and the to-be-matched user are situated in different regions, the second score is equal to a value of P₂ that is smaller the value of P₁ (say, 0).

In another example, the second score is negatively correlated to a distance between the locations respectively of the requiring user and the to-be-matched user.

In the case that the exercise information of each user as received in step S2 includes the difficulty of exercise, the category of exercise, the heart rate, the speed of the user, the stride length of the user, the step count and the travelled route, the flow proceeds to sub-step S423. In sub-step S423, the processor unit 11 continues the matching analysis to calculate the matching score for each to-be-matched user with reference further to the above-mentioned data included in the exercise information of the requiring user and the to-be-matched user. In this embodiment, one or more supplement scores may be calculated with reference to the above-mentioned data included in the exercise information associated with the requiring user and the to-be-matched user, in a manner similar to calculating the first and second scores.

For example, the “difficulty of exercise” may be a number or a coefficient indicating the challenge related to the particular exercise performed by the user. For example, when the exercise tracking device 4 detects that the user is doing uphill running and/or is running in a higher speed, the corresponding difficulty of exercise may be determined to be higher (i.e., a larger number or coefficient will be given).

Moreover, the “travelled route” is related to the particular path which the user is taking during the exercise. For example, when the travelled route indicates that the user is moving in circles, it may be derived that the exercise likely took place in a track and field stadium. When the travelled route indicates that the user does not move his/her location during the exercise, it may be derived that the user is exercising on a treadmill or a stationary bike, etc. Accordingly, the to-be-matched user may have a relatively higher supplement score if the places (i.e., a field stadium, a gym, etc.) where the requiring user and the to-be-matched user prefer taking exercise are similar.

After sub-steps S421, 422 and/or 423, the flow proceeds to sub-step S43.

In sub-step S43, the processor unit 11 calculates the matching score for each to-be-matched user that is not filtered out in sub-step S41, according to the first and second scores obtained in sub-steps S421 and S422, and (optionally) the supplement score obtained in sub-step S423. In one embodiment, the matching score is calculated by assigning a first weight and a second weight respectively to the first score and the second score to obtain a first weighted score and a second weighted score, and calculating the matching score as a summation of the first weighted score and the second weighted score.

Alternatively, the matching score may be calculated by comparing each related exercise duration/time/location set of the exercise information of the requiring user with each related exercise duration/time/location set of the exercise information of each to-be-matched user and evaluating a similarity therebetween.

In sub-step S44, the processor unit 11 compares the matching score of the to-be-match user with the predetermined matching criterion (i.e., the predetermined threshold value) stored in the storage medium 12. That is, the to-be-matched user(s) with a matching score greater than the predetermined threshold will be determined as a “match” and determined to be the matched user (s). For such user (s), the flow proceeds to step S5. Other to-be-matched user(s) will be determined as a “no match”, and the matching analysis is terminated.

In step S5, the cloud server 1 provides the user profile(s) of the matched user(s) to one of the user devices 2 that belongs to the requiring user (i.e., the user device 2 from which the friend matching request is transmitted). Then, in step S6, the user device 2 receives and displays the user profile(s) of the matched user(s) to the requiring user, such that the requiring user may interact with the matched user(s), such as by sending a message.

To sum up, the embodiment of this disclosure provides a method for expanding the use of the exercise information, and to facilitate the requirement for a requiring user to find other users with similar exercise habits, exercise patterns, etc.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for personal profile matching, the method to be implemented using a cloud server and comprising the steps of:
receiving a plurality of personal data sets respectively associated with a plurality of users, each of the personal data sets including a user profile of the user and an entry of exercise information, the exercise information including an exercise duration during which the user exercises and a location where the user exercises;
upon receipt of a friend matching request associated with one of the users, which serves as a requiring user, performing a matching analysis between the requiring user and at least one of the remaining ones of the users, which serves as a to-be-matched user, with reference to a correspondence between the exercise information of the requiring user and the exercise information of each of the to-be-matched user;
determining, using result of the matching analysis, whether or not the to-be-matched user is a matched user based on a predetermined matching criterion; and
providing the user profile of the to-be-matched user to the requiring user if it is determined that the to-be-matched user is a matched user.

2. The method of claim 1, wherein the exercise information is associated with data that is related to the exercise taken by the user and that is sensed by an exercise sensing module.

3. The method of claim 1, wherein:
in the step of performing a matching analysis, a matching score is calculated for the to-be-matched user with respect to the requiring user based on the exercise information of the requiring user and the to-be-matched user; and
in the step of determining whether the to-be-matched user is a matched user, the to-be-matched user is determined to be a matched user when the to-be-matched user has a matching score greater than a predetermined threshold.

4. The method of claim 1, wherein the step of performing a matching analysis includes the sub-steps of:
calculating a first score with reference to the exercise durations of the exercise information of the personal data sets that are respectively associated with the requiring user and the to-be-matched user;
calculating a second score with reference to the locations of the exercise information of the personal data sets that are respectively associated with the requiring user and the to-be-matched user; and
calculating a matching score according to the first score and the second score.

5. The method of claim 4, wherein in the step of performing a matching analysis, the matching score is calculated by assigning a first weight and a second weight respectively to the first score and the second score to obtain a first weighted score and a second weighted score, and calculating the matching score as a summation of the first weighted score and the second weighted score.

6. The method of claim 4, wherein, in the sub-step of calculating a first score, the first score is negatively correlated with a difference between the exercise durations respectively of the requiring user and the to-be-matched user.

7. The method of claim 6, wherein the first score is calculated by dividing a smaller one of the exercise durations by a greater one of the exercise durations.

8. The method of claim 4, wherein, in the sub-step of calculating a second score, the second score is negatively correlated to a distance between the locations respectively of the requiring user and the to-be-matched user.

9. The method of claim 4, wherein, in the sub-step of calculating a second score, the second score is equal to a first value when the locations respectively of the requiring user and the to-be-matched user are situated in the same region, and is equal to a second value, which is smaller than the first value, when the locations respectively of the requiring user and the to-be-matched user are situated in different regions.

10. The method of claim 1, wherein the exercise information further includes content selected from the following: a difficulty of exercise, a category of exercise, a heart rate, a running speed, a stride length, a step count and a travelled route.

11. The method of claim 1, wherein:
in the step of receiving a plurality of personal data sets, each of the personal data sets further includes friend preference information and physique information; and
in the step of performing a matching analysis, the matching analysis between the requiring user and the to-be-matched user is performed further based on a correspondence between the friend preference information of the requiring user and the physique information of the to-be-matched user.

12. The method of claim 1, wherein in the step of receiving a plurality of personal data sets, the cloud server receives the personal data sets respectively from a plurality of user devices that are associated respectively with the users.

13. A cloud server for personal profile matching, comprising:
a storage medium programmed for storing a plurality of personal data sets respectively associated with a plurality of users, each of the personal data sets including a user profile of the respective one of the users and an entry of exercise information, the exercise information including an exercise duration during which the respective one of the users exercises and a location where the respective one of the users exercises; and
a processor unit that, upon receipt of a friend matching request associated with one of the users which serves as a requiring user, is programmed to
perform a matching analysis between the requiring user and at least one of the remaining ones of the users, which serves as a to-be-matched user, with reference to a correspondence between the exercise information of the requiring user and the exercise information of the to-be-matched user,
determine, using result of the matching analysis, whether the to-be-matched user is a matched user based on a predetermined matching criterion stored in said storage medium, and
provide the user profile of the to-be-matched user to the requiring user if it is determined that the to-be-matched user is a matched user.

14. A system for personal profile matching, comprising:
a plurality of user devices, each of said user devices being programmed for storing a personal data set respectively associated with a user thereof, the personal data set including a user profile of the user and an entry of exercise information, the exercise information including an exercise duration during which the user exercises and a location where the user exercises; and
a cloud server that is programmed for communicating with said user devices, including a storage medium and a processor unit, and being programmed, upon receipt of a friend matching request from one of said user devices, to
perform, by said processor unit, a matching analysis between the user of said one of said user devices, which serves as a requiring user, and at least one of the users of the remaining ones of said user devices, which serves as a to-be-matched user, with reference to a correspondence between the exercise information of the requiring user and the exercise information of the to-be-matched user,
determine, by said processor unit using result of the matching analysis, whether the to-be-matched user is a matched user based on a predetermined matching criterion stored in said storage medium, and
provide the user profile of said the to-be-matched user to said one of said user devices that sends the friend matching request to said cloud server if it is determined that the to-be-matched user is a matched user.

15. The system of claim 14, wherein one of said user devices includes an exercise sensing module for sensing data related to the exercise taken by the user thereof, and for providing the exercise information associated with the data sensed thereby.

16. The system of claim 14, wherein one of said user devices is programmed for communicating with an exercise sensing module that senses data related to the exercise taken by the user of said one of said user devices, and for receiving from the exercise sensing module the exercise information associated with the data sensed by the exercise sensing module.

17. The system of claim 14, wherein one of said user devices is programmed for communicating with an exercise tracking device that includes an exercise sensing module for sensing data related to the exercise taken by the user of said one of said user devices, and for receiving from the exercise tracking device the exercise information associated with the data sensed by the exercise sensing module.

18. The method of claim 1, wherein the cloud server includes:
a storage medium programmed to store the received personal data sets; and
a processor unit that, upon receipt of the friend matching request, is programmed to execute the steps of performing the matching analysis, determining whether the to-be-matched user is a matched user, and providing the user profile.

19. The method of claim 1, wherein, the cloud server is electrically coupled to a plurality of user devices, each of the user devices is programmed for storing the personal data set respectively associated with a user thereof, and for transmitting the personal data set to the cloud server.

20. The method of claim 19, wherein one of the user devices includes an exercise sensing module for sensing data related to the exercise taken by the user thereof, and for providing the exercise information associated with the data sensed thereby.
